(19) United States
(12) Patent Application Publication
(10) Pub. No.: US 2006/0113317 A1
(43) Pub. Date: Jun. 1, 2006

(54) Portable liquid carrier and cooler

(76) Inventor: Barry Tolbert, Barstow, CA (US)

Correspondence Address: CHRISTIE, PARKER & HALE, LLP, PO BOX 7068, PASADENA, CA, 91109-7068, US

(21) Appl. No.: 10/998,213

(22) Filed: Nov. 26, 2004

(51) Int. Cl. B67D 5/06

(52) U.S. Cl. 222/78; 222/183; 222/482; 222/608

(57) ABSTRACT

The invention is a liquid carrier and cooler that has a rock-shaped exterior portion that has a shell with an open top that opens to a inner cavity that has an inner liner, a spigot recessed in a location at a lower portion of the rock-shaped exterior portion for dispensing liquid from liquid carrier and cooler, and a lid, on which appears Biblical scripture, that fits over the open top and completes the shape of the rock when engaged with the rock-shaped exterior portion.

### BACKGROUND

The invention is in the field of liquid carriers and coolers, and more particularly a portable liquid carrier and cooler that has the exterior appearance of a rock.

Having access to clean drinking water is fundamental to the maintenance of good health. It unfortunately remains all too common that people in many poor regions of the world are relegated to collect water for drinking, cooking and cleaing from rivers and other contaminated sources. This leads to these people and their families needlessly being exposed to a host of different pathogens and contaminants. In an attempt to address this serious health concern, Christian and other relief organizations are involved in drilling water wells to supply clean and safe potable water at numerous locations around the world. However, even after these wells are dug, oftentimes people must still travel great distances, often over rough terrain, with open-topped, wire handled, metal or plastic buckets, plastic jugs, etc., to transport this much-needed water to their families and villages. Much of the water can be lost to spillage and evaporation, and the process of transporting the water can be back breaking work, particularly for the weak and the ill.

The imagery of the rock combined with water has powerful religious symbolism and significance to many Christians. For example, 1 Corinthians 10:4, proclaims: “and all drank the same spiritual drink. For they drank of the spiritual Rock that followed them, and that Rock was CHRIST”. (The World English Bible.) Many Christians attach great reverence to Biblical references and make a concerted effort to conform their thoughts and actions accordingly.

There is great incentive for Christians, particularly those in poverty stricken areas of the world where it is necessary to build strong concepts and habits of maintaining drinking water in a clean and pure manner, for a water cooler to somehow be connected with the powerful Christian image of a rock. There accordingly remains a need for a water carrier and cooler that has the exterior appearance of a rock that is portable and which easily permits water to be readily moved over distance.

### BRIEF DESCRIPTION OF THE DRAWINGS

Further advantages of the invention will become apparent upon a reading of the following detailed description taken in conjunction with the accompanying drawings.

FIG. 1 is a front view of a first, exemplary embodiment of a rock-shaped liquid carrier and cooler of the invention with the lid attached to the base portion.

FIG. 2 is a front view of a first, exemplary embodiment of a rock-shaped liquid carrier and cooler of FIG. 1 but with the lid detached from the base portion.

FIG. 2A is a detail front view of the lid partially lifted from the base portion.

FIG. 2B is a bottom view of the lid;

FIG. 3 is a side perspective view of the first, exemplary embodiment of a rock-shaped liquid carrier and cooler of FIG. 1 showing its carrying handle.

FIG. 4 is a partial cutaway view of the first, exemplary embodiment of a rock-shaped liquid carrier and cooler of FIG. 3.

FIG. 5 is a top perspective view of the first, exemplary embodiment of a rock-shaped liquid carrier and cooler of FIG.

FIG. 6 is a side perspective view of the second, exemplary embodiment of a rock-shaped liquid carrier and cooler with carrying handles.

FIG. 7 is a side view of a third exemplary embodiment of a rock-shaped liquid carrier and cooler having wheels and an extendable handle.

FIG. 8 is a rear view of the third exemplary embodiment of a rock-shaped liquid carrier and cooler of FIG. 7.

FIGS. 9A-9G are views of pressure relief devices to help prevent vacuum lock while liquid is dispensed from the liquid carrier and cooler.

FIGS. 10 is a front view of a lid with an exemplary embodiment of a second groove design.

FIG. 11 is a front view of a lid with an exemplary embodiment of a third groove design.

FIG. 12 is a bottom view of a lid with an exemplary embodiment of a FIGS. 10 or 11.

FIGS. 13A-C are cross-sectional views of exemplary vent grooves.

FIG. 14 is a front view of an exemplary sealed bearing wheel, utilizing a flat-proof tire, for a rollable cooler of the invention.

FIG. 15 is a cross-section of the wheel of FIG. 14.

FIG. 16 is a front view of another exemplary sealed bearing wheel, utilizing a different flat-proof tire, for a rollable cooler of the invention.

FIG. 17 is a cross-section of the wheel of FIG. 16.

### DETAILED DESCRIPTION OF THE INVENTION

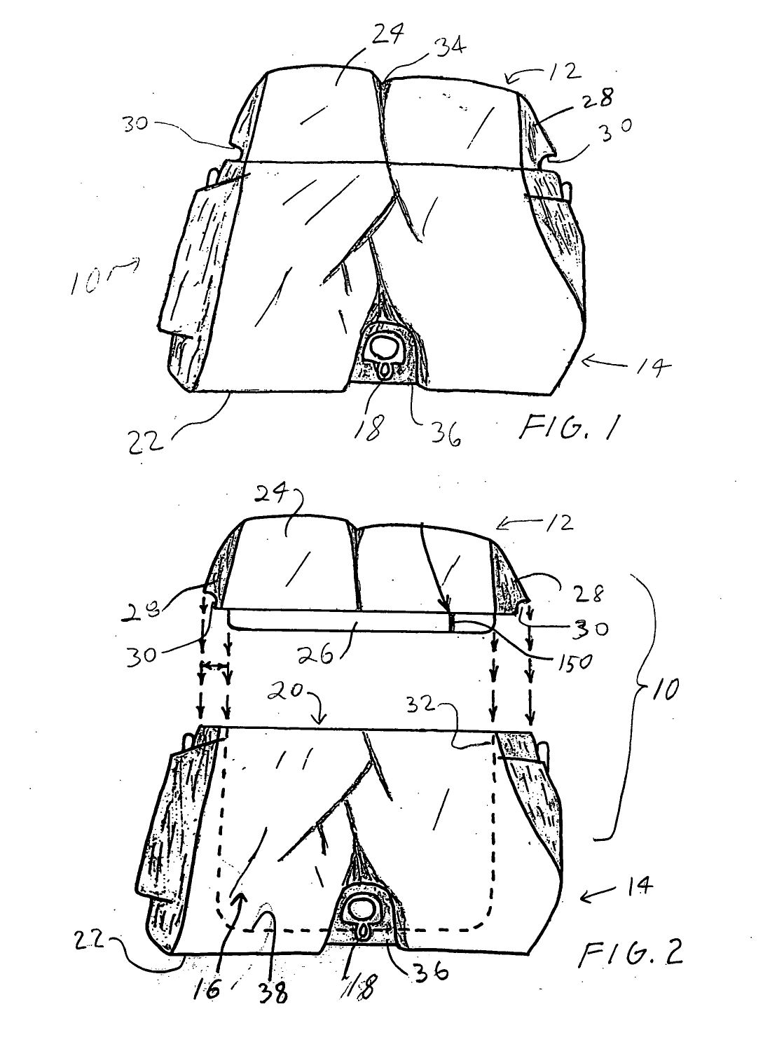

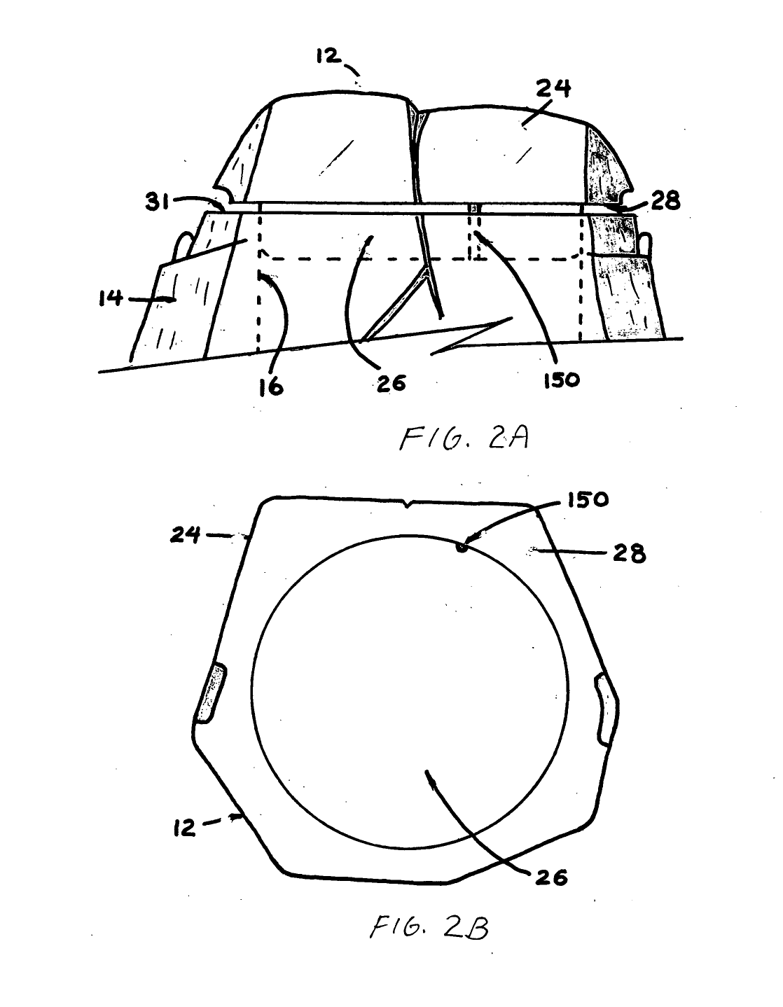

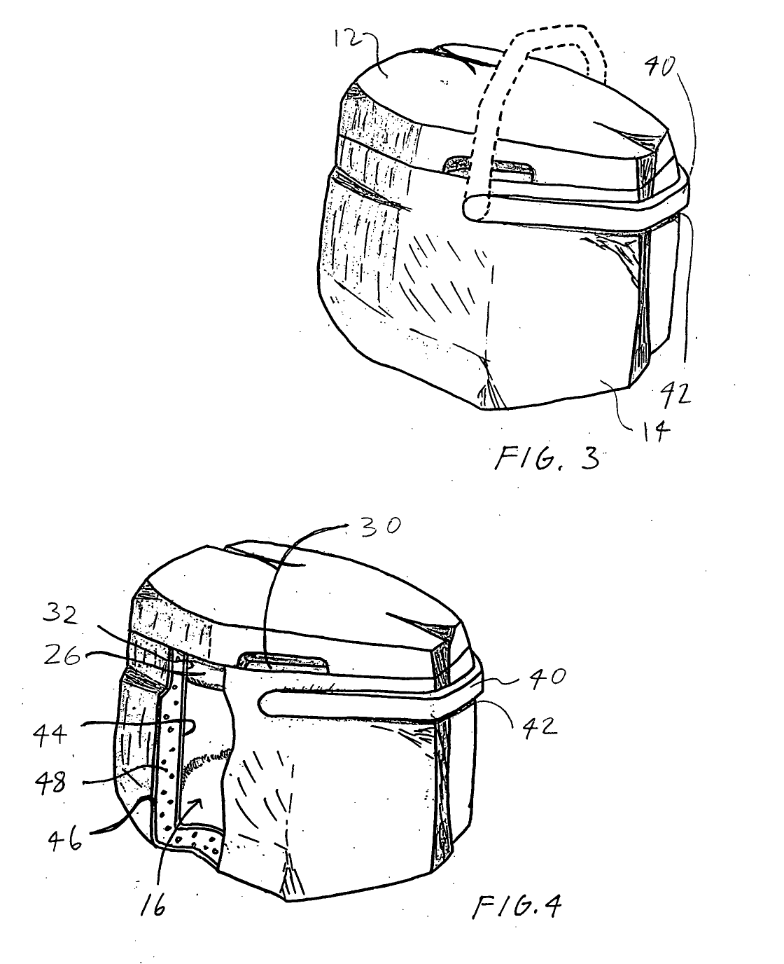

Referring to FIGS. 1 and 2, there is shown a front view of a first, exemplary embodiment of a rock-shaped liquid carrier and cooler 10 of the invention with a lid portion 12 and a base portion 14. The lid portion 12 and base portion 14 both have an exterior appearance that generally resembles a rock. The base portion 14 has an inner cavity 16 located therein and has a liquid outlet 18, e.g., a spigot or thumb valve, preferably near a bottom 38 of the inner cavity 16 for dispensing liquid. The inner cavity 16 has an open top 20. The inner cavity 16 can comprise a sanitary inner liner (e.g. smooth plastic), and the exterior surface of the rock-shaped base portion can comprise a shell, as best shown in FIG. 4. The base portion 14 preferably has a generally flat bottom 22 so that the base portion 14 can be placed on a surface in a stabile manner. The lid portion 12 has an upper portion 24 and a lower portion 26. The upper portion 24 has the generally appearance of a rock, and when placed with its lower portion 26 into the open top 20 of the base portion 14, is complementary to the general rock-shape exterior of the base portion 14. The lower portion 26 of the lid 12 will preferably establish a snug fit with an upper rim area 32 of the inner cavity 16. A venting grove 150 is located on lower portion 26 of lid to provide for venting between the interior of the base portion 14 and the lid 12. As shown, the lid 12 has a perimeter 28 that overlaps the base portion beyond its open top 20. This overlap helps to keep the contents of the cooler free from infiltration of dirt, dust and possible contaminants. The lid 12 preferably includes finger grips 30 which will provide a surface upon which a user can grasp the lid 12 to aid in removing the lid 12 from the base portion 14. As can be seen, the lid 12 and base portion 14 when engaged together, form a generally rock-shaped cooler, with “fissures” 34 and other irregularities provided to give the liquid carrier its rock shape. The exterior of the cooler 10 is preferably provided in colors and textures that match authentic rock to mimic a real rock. The liquid outlet 18 can be located in a recessed area 36 so that the liquid outlet 18 does not protrude and appears to be hidden so as not to interfere with the generally rock-shaped appearance of the liquid carrier 10. The rock-shaped liquid carrier and cooler 10 can be sized as desired, but sizes varying from about 1 to 3 gallons (3.785 to 11.625 liters) can be easily carried by a single person in this embodiment.

FIG. 2A is a detail front view of the lid partially lifted from the base portion, and FIG. 2B is a bottom view of the lid.

The placement of a generally vertical groove or grooves 150 into the perimeter edge of the lower portion 26 of the lid portion 12 serves at least two purposes. First, as the lid lower portion 26 is pushed into the base inner cavity 16, trapped air is allowed to escape up and through the groove or grooves 150 and out between the lid perimeter overlap 28 and the upper edge of the base 31, to prevent the lid from being pushed partially or completely back out of the base inner cavity 16 due to the compression of the air between the contents of the container and the lower portion of the lid 26. Secondly, with the lid portion 12 applied to the filled base portion 14 of the container/dispenser, air is allowed to enter into the base inner cavity 16 between the lid perimeter overlap 28 and the upper edge of the base 31, then down and through the generally vertical groove or grooves 150 to prevent a vacuum-lock condition, while the contents are being dispensed. With the air intake groove or grooves 150 being located under the lid perimeter overlap 28, debris is much less likely to be drawn into the container during venting. The venting method is well suited for either an insulated or hollow lid.

FIG. 3 is a side perspective view of the rock-shaped liquid carrier and cooler 10 of FIG. 1 showing its carrying handle 40 in a flipped down position folded into an optional recess 42 formed into the base portion 14, and showing (in phantom lines) the raised position of the carrying handle 40 in its carrying position.

FIG. 4 is a partial cutaway view of the rock-shaped liquid carrier and cooler 10. The inner cavity 16 is shown as comprising an inner liner 44, and the exterior surface of the rock-shaped base portion can comprise a shell 46 (e.g. high impact plastic) that is formed into the shape of a rock. For thermal insulation, thermal insulation material 48, such as any low expansion, polystyrene, polyurethane, latex-based, soy-based or other known “rigid foam” insulation product, deemed most suitable for insulation of potable water containers, can be placed between the inner liner 44 and shell 46. The lid 12 can comprise a one-piece hollow unit. Although not shown, the lid 12 can also optionally have insulation material placed between rock-shaped upper portion 24 and its lower portion 26.

FIG. 5 is a top perspective view of the rock-shaped liquid carrier and cooler 10 showing a location 60 where a logo, trademark, and/or textual material (graphical subject matter), such as Biblical scripture can optionally appear on an upper surface 62 of the lid 12. This can be by molding into lid, printing, a sticker, or other known ways. The logo, trademark, and/or textual material can also appear on other portions of the liquid carrier's lid and/or base portion. The logo, trademark, and/or textual material can selected for maximum impact on the user of the cooler. Religious and sacred images and/or Biblical scripture, such as the Cross and/or 1 Corinthians 10:4, “and all drank the same spiritual drink. For they drank of the spiritual Rock that followed them, and that Rock was CHRIST” can be placed on the lid 12.

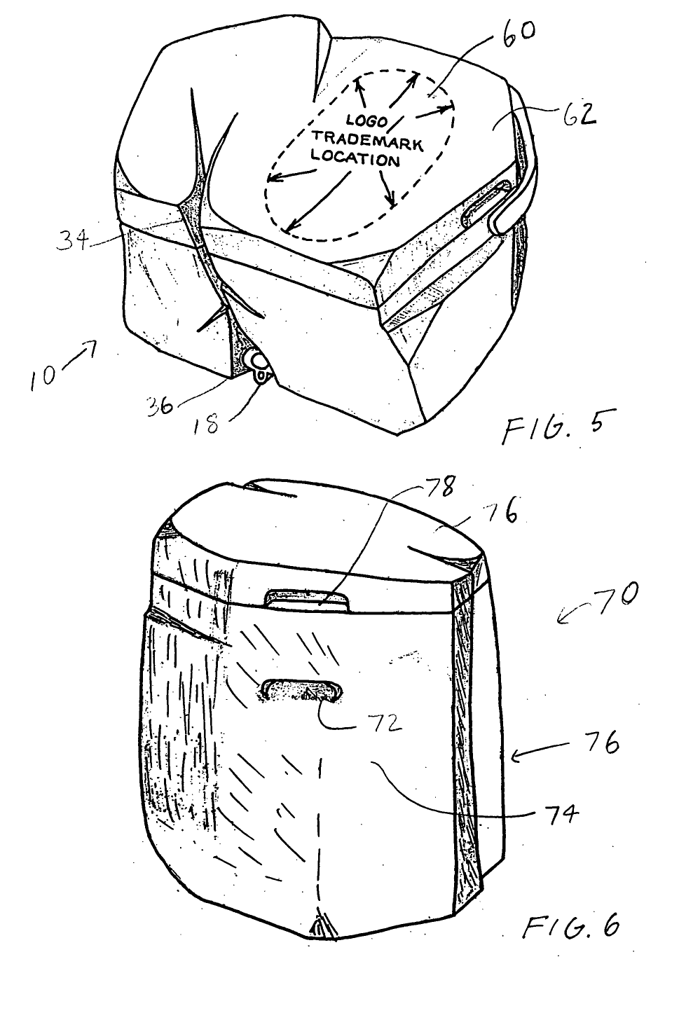

FIG. 6 is a side perspective view of the second, exemplary embodiment of a rock-shaped liquid carrier and cooler 70 of the invention having carrying grips 72 formed on sides 74 of a base portion 76. As with the first embodiment 10, the base portion 76 will have a inner cavity located therein and has a liquid outlet, e.g., a spigot or thumb valve, preferably near a bottom of the liquid carrying for dispensing liquid (not shown), and can be thermally insulated. Religious and sacred images and/or Biblical scripture, can be placed on a lid 78 and/or base portion 76 of the liquid carrier 70. The carrying grips 72 are preferably formed, e.g., by molding, into opposite sides 74of the base portion 76. The liquid capacity of this embodiment can preferably be from about 5 to 15 gallons (19.375 to 58.125 liters), but could be other desired sizes.

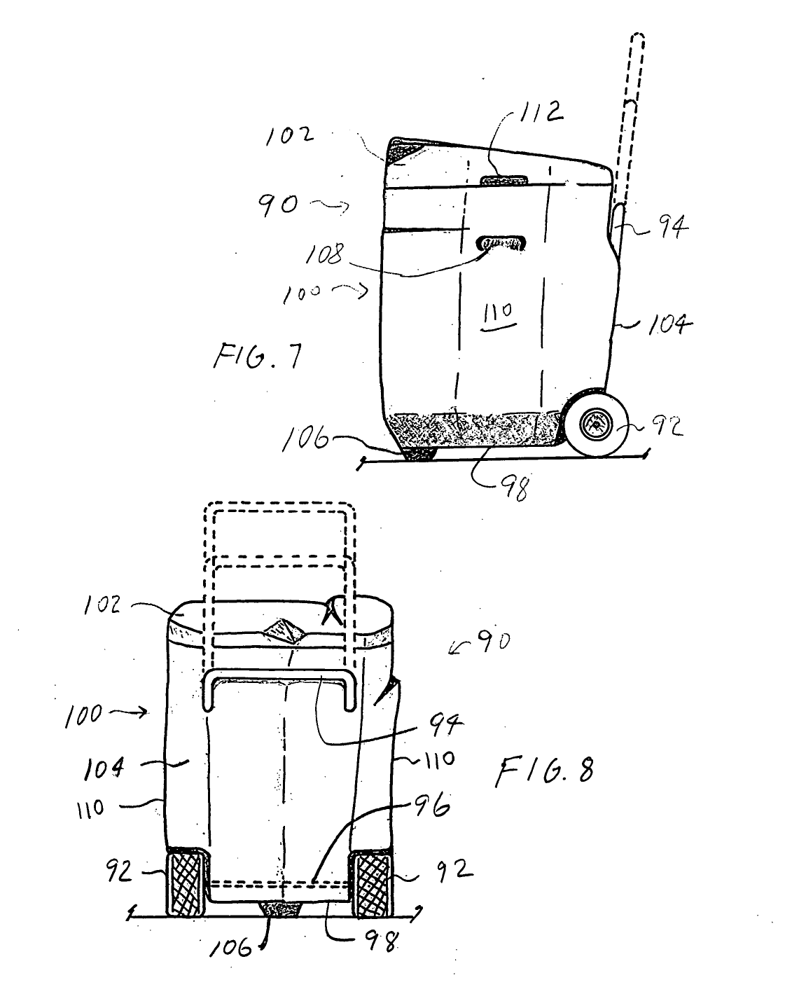

FIGS. 7 and 8 are a side and rear view, respectively, of a third exemplary embodiment of a rock-shaped liquid carrier and cooler 90 having tire/wheel assemblies 92 and an extendable handle 94. The tire/wheel assemblies 92 can preferably be mounted on an axle 96, and the tire/wheel assemblies 92 extend below a bottom surface 98 of a base portion 100 of the liquid carrier. The axle 96 can comprise a solid steel axle and the tire/wheel assemblies 92 are preferably made to be wide and large to permit the liquid carrier 90 to be moved easily over soft or rough surfaces such as sand, grass, gravel, rough roads and paths. The tires on assemblies 92 can be solid, semi-pneumatic or pneumatic filled with a pliable foam material, to be rendered flat-proof. A lid 102 engages with an open top of the base portion (not shown), and the lid 102 can be attached to the base portion 100 (e.g., by a hinge or lanyard—not shown) or can be freely separable from the base portion 100. As shown, the extendable handle 94 can be extended by different degrees (shown in phantom lines) to accommodate the needs of different users (e.g., users of different heights). When not in use, the handle 94 can be moved back into a back wall 104 of the base portion 100. In order to maintain the bottom surface 98 of the base unit 100 in a fairly horizontal position, a front support 106 extends downwardly to maintain the liquid carrier and cooler in a generally level position when not being moved. Hand grips 108 are preferably placed on sides 110 of the base portion 100. These hand grips 108 can, for example, be molded into side walls 110 of the base portion 100. As with the first and second embodiments 10 and 70, the base portion 100 will have a cavity located therein and has a liquid outlet, e.g., a spigot or thumb valve, preferably near a bottom of the cavity for dispensing liquid (not shown), and is preferably thermally insulated. Finger grips 112 can be located on the lid for a user to lift the lid 102 to access the cavity in the base portion 100. Sacred and religious images and/or Biblical scripture, can be placed on the lid 102 and/or base portion 100 of the liquid carrier and cooler 90 to provide additional inspiration to the user and serve as a reminder of the sacredness of the water, liquid or other items being transported and stored in the liquid carrier and cooler 90. The liquid capacity of this embodiment can preferably be from about 5 to 15 gallons (19.375 to 58.125 liters), but can be other desired sizes.

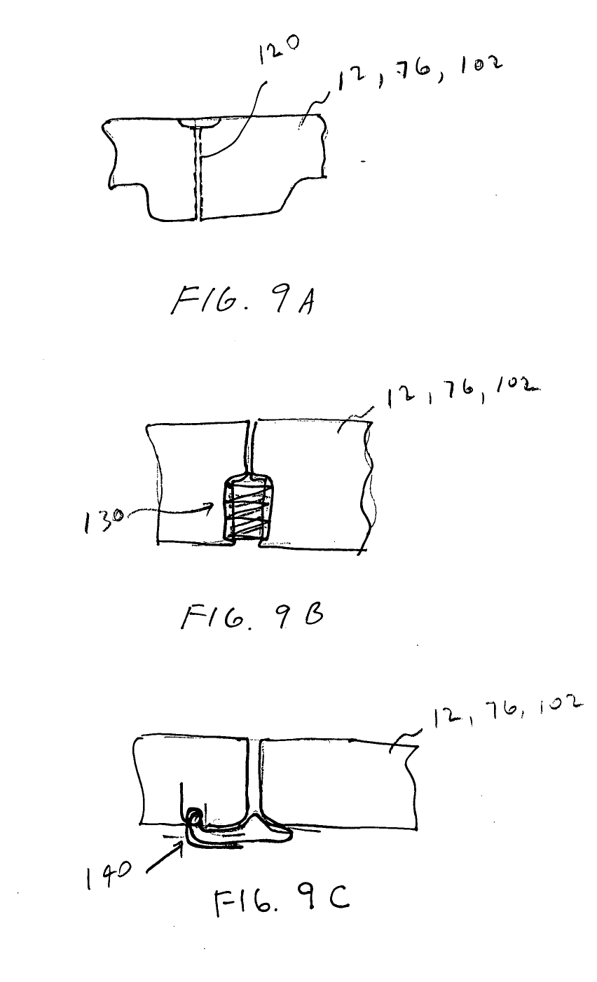

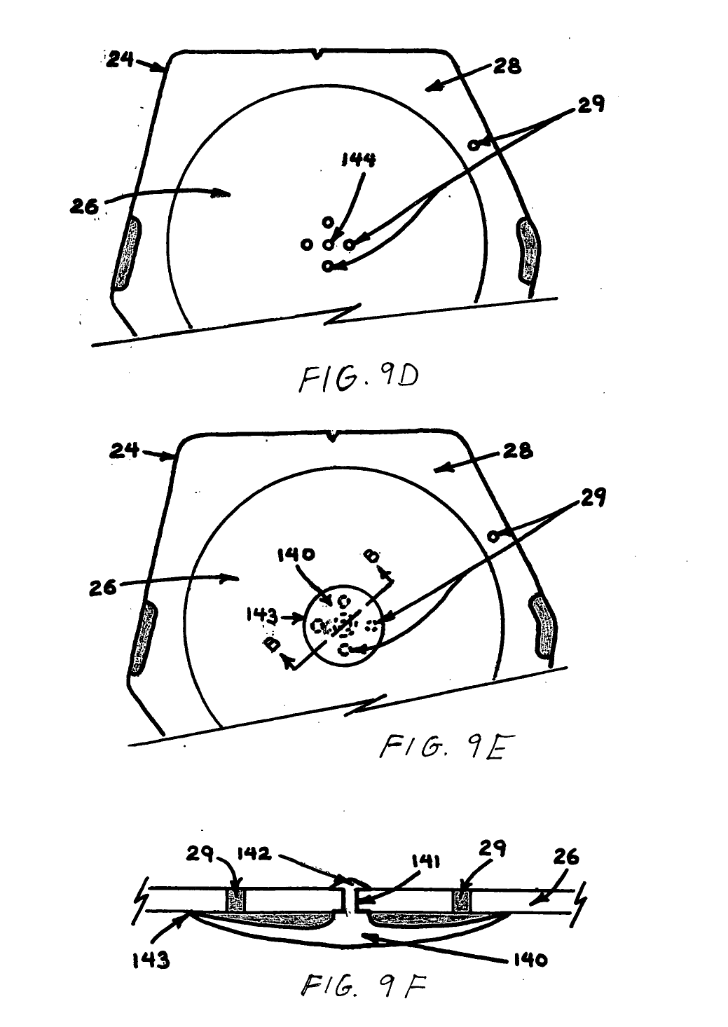

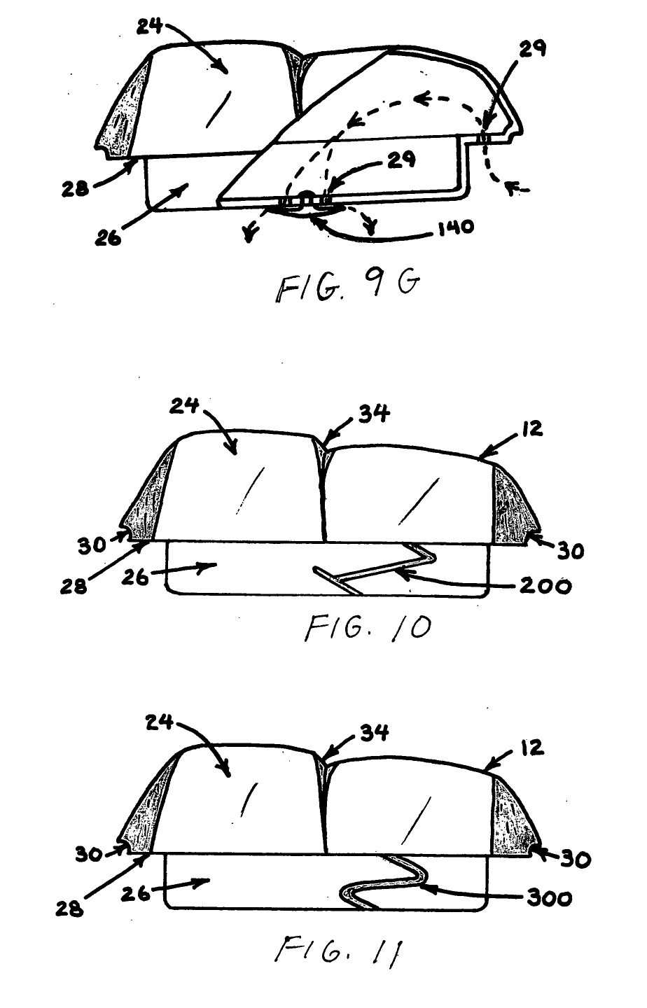

FIGS. 9A-9G are views of pressure relief devices 120, 130 and 140, respectively, to help prevent vacuum lock while liquid is dispensed from each of the liquid carrier and cooler shown and described. FIG. 9A shows an exemplary pressure relief device in the form of a vent aperture 120 formed through the lid 12, 76 or 102. FIG. 9B shows an exemplary internal check valve 130 placed in the lid 12, 76 or 102, and FIG. 9C shows an exemplary pressure relief device in the form of a flapper valve 140 placed in the lid 12, 76 or 102. FIGS. 9D-9G are views of a mushroom type pressure relief valve, with FIG. 9D being a bottom view of the lid without a valve shown, FIG. 9E being a bottom view of the lid with a valve being shown, FIG. 9F being a cross-sectional view of a flapper valve, and FIG. 9G being a lid cutaway showing operation of the mushroom valve.

FIG. 9D shows the location of the valve-mounting holes 144 and air inlet openings 29 in the bottom of the lid perimeter overlap 28 of the lid lower portion 26. FIG. 9E illustrates how a mushroom-shaped valve 140 will cover the air inlet openings 29, located in the bottom of the lid lower portion 26, between the valve-mounting hole 144 and the outer lip/rim 143 of the valve. FIG. 9F shows the shape of valve 140, detailing the retaining stem 141 and tapered retaining flange 142 portion of the valve. The outer lip/rim 143 of the cup shaped portion of the valve 140 forms a circular “seal” against the bottom of the lid lower portion 26, around the outside of the air inlet openings 29. FIG. 9G is a cutaway view showing the pathway of air, in and through the hollow lid, past the outer lip/rim 143 of the valve 140 and not the container cavity, as its contents are being dispensed.

With the venting mechanism of FIGS. 9D-9G, as the contents of the container are being dispensed, the vacuum created inside the container cavity overcomes the tension on the outer lip/rim 143 of valve 140 against the bottom of the lower portion of the lid 26, breaking the seal between these two surfaces. When this seal is broken, air is drawn up through the outer air inlet opening 29 in the bottom of the lid perimeter overlap area 28, through the hollow lid, down through the inner air inlet openings 29 in the bottom of the lid lower portion 26, past the outer lip/rim 143 of the flapper valve 140 and into the container cavity to prevent a “vacuum-lock” condition.

This venting mechanism is not as simple as the “groove type” venting design as it uses a flexible, self-tensioning valve 140, along with air inlet openings 29 to accomplish the venting. As this valve 140 is molded/formed of a pliable rubber or plastic, no corrosive parts are used which might contaminate the contents of the container. With the outer air inlet opening 29 being located under the lid perimeter overlap 28, debris is not likely to be drawn into the container, while the contents are being dispensed. This venting system is best suited for use with a hollow lid.

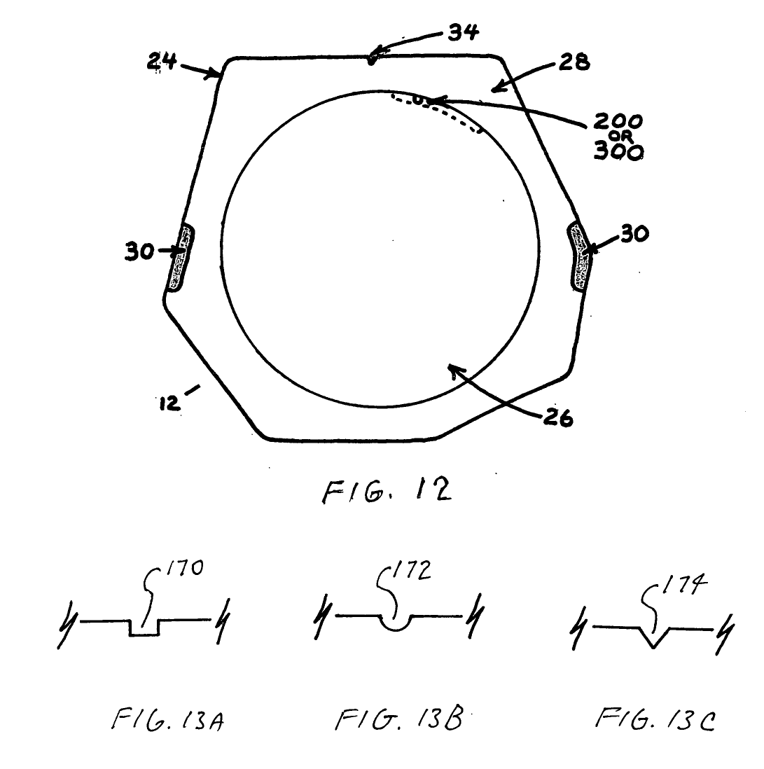

FIGS. 10 and 11 is a front view of a lid with an exemplary embodiment of a second and third groove design, respectively, with FIG. 12 is a bottom view of a lid with an exemplary embodiment of a FIGS. 10 or 11. While use of a venting groove is a practical method to vent a lid, the use of vertical venting grooves has the potential to allow the contents to be sloshed up from the container and out through the grooves during transportation and/or if the container is slightly tipped, while full or near full.

To address the problem of the contents of the container being sloshed up and out, through the vertical venting grooves, the unique venting groove configurations 200 and 300 of FIGS. 10 and 11 are provided.

The use of a groove such as 200 or 300, where the contents would have to enter an angular entrance opening - - - be forced to turn and flow up a ramp - - - be forced again to turn - - - then to exit up and out of an “angular exit” opening, will reduce (if not eliminate) the escape of the container contents, caused by sloshing up and out through that groove. These uniquely configured venting grooves can also be stretched further, laterally, across and/or around the perimeter edge of the lid lower portion, than is illustrated in 200 and 300, to improve their effectiveness. The use of a narrow and shallow groove profile can also improve the effectiveness of such a uniquely configured venting groove.

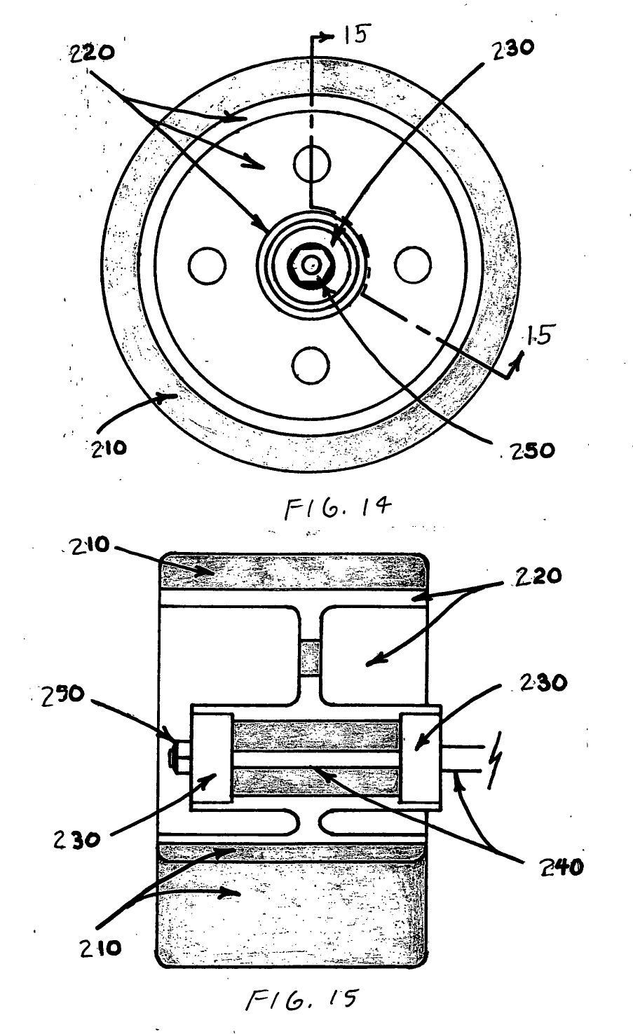

The width and depth of the groove profile used in the venting grooves can effect the rate at which air is allowed to enter through that groove. Therefore, if the use of one long, narrow and shallow uniquely configured venting groove proved to be restrictive to the flow of the venting air, as the contents are being dispensed, more grooves could be placed, as needed, around the lower projection of the lid, to provide adequate air intake. FIGS. 13A,B and C are some exemplary venting groove profiles, including a rectangular profile 170, a semicircular profile 172 and a V-shaped profile 174.

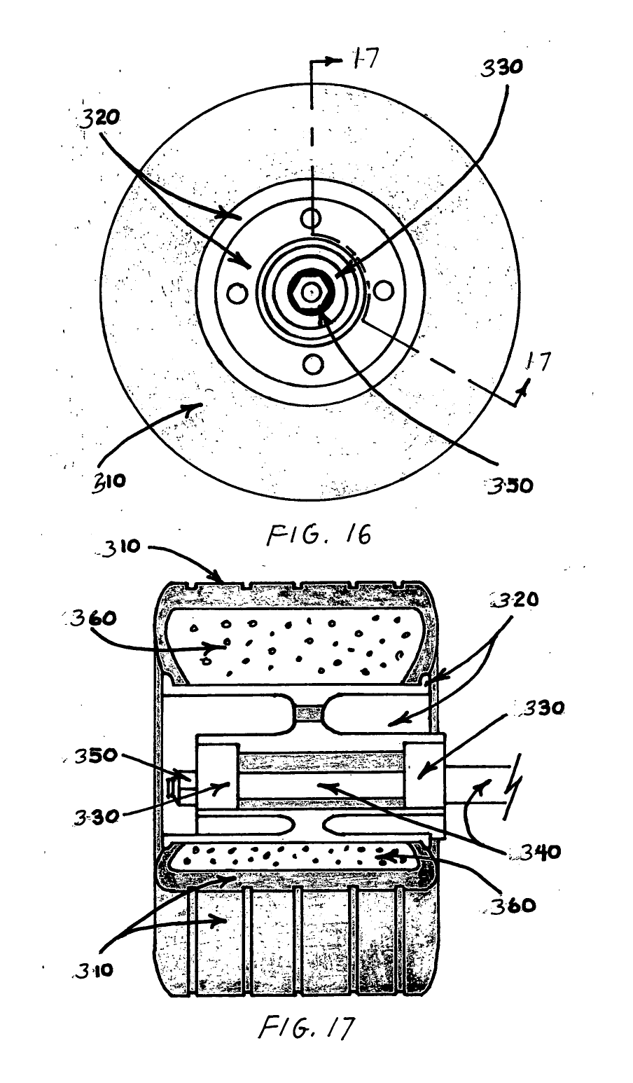

FIGS. 14 and 15 are front and cross-sectional views, respectively, of a “flat-proof” tire/wheel assembly, to be used on the Roll-About version of the container/dispensers of FIGS. 7 and 8. This embodiment utilizes a solid tire 210 of polyurethane or rubber, which is bonded to a rim/wheel 220. This rim/wheel 220 will be formed of either a high impact plastic/resin or a lightweight metal (e.g. aluminum, magnesium or suitable lightweight alloy). Sealed and lifetime lubricated bearings 230 (e.g. ball, roller or needle bearings) are pressed into both sides of the center section of the rim/wheel 220. One tire/wheel assembly, with bearings, will mount onto opposite ends of a solid steel axle 240 and be retained to the axle 240 with either a threaded nut or other suitable retainer 250. These tire/wheel assemblies will be specifically engineered in width, height and bearing size, to provide the needed flotation, ground clearance and load carrying capacity, proportionate to the size and gross weight of the container/dispenser upon which they will be used.

FIGS. 16 and 17 are front and cross-sectional views, respectively, of a second exemplary embodiment of a “flat-proof” tire/wheel assembly, which is suitable for use in such an application. In this embodiment, an appropriate sized, conventional pneumatic tire 310 is mounted onto a rim/wheel 320. The air inside this pneumatic tire is replaced with a pliable, foam filler product 360 (e.g. polyurethane or other cellular foam), to render the tire 310 flat-proof. This rim/wheel 320 will also be formed from high impact plastic/resin or from a lightweight metal product. Sealed and lifetime lubricated bearings 330 are also pressed into the center sections of these rim/wheel assemblies, which are retained at opposite ends of the solid steele axle 340, by threaded nuts or other suitable retainers 350. These tire/wheel assemblies and bearings are sized appropriately for their application.

Although not illustrated, there are other flat-proof tire options, which may also prove suitable for use in this application and would be mounted on rim/wheel assemblies such as those illustrated in FIGS. 16 and 17. For example, “semi-pneumatic” rubber tires have been used in similar applications for many years, but may prove to be less durable than those described above. Also, flat-proof, one piece, micro-cellular polyurethane foam tires are also currently available, although the high cost of these tires may prove prohibitive for this application. The use of appropriately sized, flat-proof tire/wheel assemblies utilizing sealed and lifetime lubricated bearings, will enable these containers/dispensers to traverse a vast array of terrains and endure the harshest of conditions for many years.

Although primarily designed to carry liquid, the liquid carrier and cooler 10, 70 and 90 of the invention can also be used to carry not just liquids like water, but can be used to carry other items (e.g. food, packaged drinks, items that need to be cooled, etc.) in the inner cavity if desired. Also, while the FIGS. show the various embodiments of the liquid carrier and cooler of the invention having certain rock-shaped designs, these are meant to be exemplary designs and are not intended to be limiting in any way.

Although a preferred embodiment of the present invention has been described, it should not be construed to limit the scope of the appended claims. For example, the present liquid carrier and cooler may be implemented to include a variety of different sizes, shapes, and colors to give the appearance of rocks.

In addition, those skilled in the art will understand that various modifications may be made to the described embodiment. Moreover, to those skilled in the various arts, the invention itself herein will suggest solutions to other tasks and adaptations for other applications. It is therefore desired that the present embodiments be considered in all respects as illustrative and not restrictive, reference being made to the appended claims rather than the foregoing description to indicate the scope of the invention.

1. A rock-shaped liquid carrier and cooler, comprising:
a base portion with a rock-shaped exterior and an inner cavity;
a liquid outlet that is in liquid communication with the inner cavity for dispensing liquid from liquid carrier and cooler; and
a lid that fits over the inner cavity.

2. The rock-shaped liquid carrier and cooler of claim 1, further comprising Biblical scripture on the lid.

3. The rock-shaped liquid carrier and cooler of claim 1, wherein the liquid carrier and cooler is thermally insulated.

4. The rock-shaped liquid carrier and cooler of claim 1, wherein the inner cavity comprises an inner liner and the rock-shaped exterior comprises a shell.

5. The rock-shaped liquid carrier and cooler of claim 4, wherein thermal foam insulation is placed between the inner liner and the shell.

6. The rock-shaped liquid carrier and cooler of claim 1, wherein the lid has an upper portion and a lower portion, wherein the upper portion completes the shape of the rock when engaged with the base portion, and the lower portion fits into an opening of the inner cavity to retain and seal the lid onto the base portion.

7. The rock-shaped liquid carrier and cooler of claim 6, wherein the lid has a perimeter edge which overlaps an upper edge of the base portion.

8. The rock-shaped liquid carrier and cooler of claim 6, wherein the lid has at least one finger grip to aid in removing the lid from the base portion to access the inner cavity.

9. The rock-shaped liquid carrier and cooler of claim 1, further comprising a pressure release device to help prevent vacuum lock while the liquid is dispensed from the liquid carrier and cooler.

10. The rock-shaped liquid carrier and cooler of claim 9, wherein the pressure release device is selected from the group consisting of an internal check valve, a flapper valve, and a vent aperture formed in at least one of the lid and inner cavity.

11. The rock-shaped liquid carrier and cooler of claim 6, further comprising a pressure releasing vent groove located between the lower portion of the lid and the opening of the inner cavity.

12. The rock-shaped liquid carrier and cooler of claim 11, wherein the vent is vertically formed in the lower portion of the lid.

13. The rock-shaped liquid carrier and cooler of claim 11, wherein the vent is circuitously formed in the lower portion of the lid.

14. The rock-shaped liquid carrier and cooler of claim 1, further comprising a carrying handle.

15. The rock-shaped liquid carrier and cooler of claim 14, wherein the handle will fold down into a recess in the base portion when not in use.

16. The rock-shaped liquid carrier and cooler of claim 1, wherein the liquid outlet comprises a thumb valve or spigot recessed in a location at a lower portion of the base portion.

17-24. (canceled)

25. A rock-shaped liquid carrier and cooler, comprising:
a base portion with a rock-shaped exterior that comprises a shell with an open top that opens to an inner cavity that comprises an inner liner;
a spigot located in a recess at a lower portion of the rock-shaped exterior for dispensing liquid from inner cavity; and
a lid upon which appears graphical subject matter that fits over the open top and completes the shape of the rock when engaged with the rock-shaped exterior portion of the base portion.

26. The rock-shaped liquid carrier and cooler of claim 25, wherein thermal foam insulation is placed between the inner liner and the shell.

27. The rock-shaped liquid carrier and cooler of claim 25, wherein the lid has an upper portion and a lower portion, wherein the lower portion fits into the opening of the inner cavity to retain and seal the lid onto the base portion.

28. The rock-shaped liquid carrier and cooler of claim 25, wherein the lid has a perimeter edge which overlaps an upper edge of the base portion.

29. The rock-shaped liquid carrier and cooler of claim 25, further comprising a pressure release device to help prevent vacuum lock while the liquid is dispensed from the liquid carrier and cooler.

30. The rock-shaped liquid carrier and cooler of claim 25, further comprising a carrying handle.

31-34. (canceled)

35. The rock-shaped liquid carrier and cooler of claim 27, further comprising a pressure releasing vent groove located between the lower portion of the lid and the opening of the inner cavity.

36. The rock-shaped liquid carrier and cooler of claim 35, wherein the vent is vertically formed in the lower portion of the lid.

37. The rock-shaped liquid carrier and cooler of claim 35, wherein the vent is circuitously formed in the lower portion of the lid.
